(19) United States
(12) Patent Application Publication
(10) Pub. No.: US 2009/0308083 A1
(43) Pub. Date: Dec. 17, 2009

(54) Method for Filling a Pressure Vessel, Provided for a Cryogenic Storage Medium, in particular Hydrogen

(75) Inventor: Tobias BRUNNER, Unterhaching (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 12/546,998

(22) Filed: Aug. 25, 2009

Related U.S. Application Data
(63) Continuation of application No. PCT/EP2008/052314, filed on Feb. 26, 2008.

(30) Foreign Application Priority Data
Mar. 9, 2007 (DE) 10 2007 011 530.1

(51) Int. Cl. F17C 9/02

(52) U.S. Cl. 62/50.2

(57) ABSTRACT

In a method for filling a cryo-compressed tank of a motor vehicle with a cryogenic storage medium, such as hydrogen, which can be stored in the tank under absolute pressure values in an order of magnitude of 150 bar or more, the hydrogen is taken in the liquid state at a suitable saturation temperature under essentially ambient pressure from a large supply vessel. Following removal from the large supply vessel, the hydrogen is compressed essentially adiabatically with a cryo pump and then is introduced at super critical pressure (13 bar or more) into the cryo-compressed tank. Preferably beforehand it is also re-cooled to approximately 20 K passing it through a heat exchanger, disposed in the hydrogen, stored in the large supply vessel. Before filling with new storage medium, the residual storage medium, contained in the cryo-compressed tank, can be removed from the cryo-compressed tank and introduced into the large supply vessel.

### CROSS REFERENCE TO RELATED APPLICATIONS

This application is a continuation of PCT International Application No. PCT/EP2008/052314, filed Feb. 26, 2008, which claims priority under 35 U.S.C. §119 to German Patent Application No. 10 2007 011 530.1, filed Mar. 9, 2007, the entire disclosure of which is herein expressly incorporated by reference.

### BACKGROUND AND SUMMARY OF THE INVENTION

The present invention relates to a method for filling an insulated pressure vessel (particularly a cryo-compressed tank of a motor vehicle) which is provided for a cryogenic storage medium such as cryogenic hydrogen. The cryogenic storage medium, which is taken in the liquid state at suitable saturation temperature (essentially under ambient pressure) from a large supply vessel, can be stored in the insulated pressure vessel under absolute pressure values on the order of magnitude of 150 bar or more.

With regard to the known prior art, reference is made not only to the tank filling technology, which is currently used, for example, in the “Hydrogen 7” vehicle of the assignee of the present patent application, and which is explained in the following paragraph, but also German patent document DE 41 29 020 C2, and U.S. Pat. No. 6,708,502 B1, as well.

The “Hydrogen 7” vehicle, which is equipped with a so-called cryo tank for storing cryogenic hydrogen (for supplying the vehicle drive unit, configured as an internal combustion engine), utilizes a “sub-critical” liquid hydrogen storage vessel as the cryo tank. The latter consists of a metal inner tank, a metal outer tank, and a vacuum super insulation, which is sandwiched between the two tanks and which serves to reduce the introduction of heat into the inner tank. The typical operating pressure of this storage vessel ranges from 1 bar absolute to 10 bar absolute, and the operating temperatures in the so-called “standard cryogenic operation” range from 20 K (Kelvin) to approximately 30 K. That is, the cryogenic hydrogen, contained in the storage vessel (or more specifically in the inner tank), exhibits these physical values, which lie in the so-called sub-critical range in the pressure-density diagram of the hydrogen. The maximum system storage densities that have been achieved to date in this manner are below 30 grams of hydrogen per liter of system volume, which include not only the cryo tank, but also all of the auxiliary systems that are necessary for operating the fuel supply system. This is equal to a volumetric system energy density of less than 1 kWh per liter of system volume.

According to this prior art, the cryo tank is filled with cryogenic liquid hydrogen at a pressure ranging from 1 bar to 6 bar, and at corresponding saturation temperatures of the cryogenic hydrogen or with slight sub-cooling of the same. The current maximum achievable subcooling is in the range of 6 Kelvin, as the difference between the saturation temperature at a pressure of 6 bar absolute and the saturation temperature at a pressure of 1 bar absolute. The physical storage densities are limited by the maximum tank filling pressure of approximately 6 bar absolute and the lowest possible hydrogen temperature of approximately 20 K and achieve values of a maximum 71.5 g/l. A standard vehicle tank filling process is limited currently by the minimum pressure requirement of the vehicle drive unit, on the one hand, and by the lack of an “overfillability,” on the other hand,—usually an approximately 80% to 95% liquid volume fill limit of the cryo tank applies. Therefore, a cryo tank, according to the then existing state of the art, does not achieve the aforementioned maximum possible physical storage densities.

At the same time there exists a so-called “boil off problem” of past cryo tanks. In this case the minimal, but unavoidable addition of heat into the cryo tank causes the pressure to increase in the cryo tank (self-pressurization). The resulting pressure must be decreased by venting the gaseous hydrogen from the cryo tank. When switched off, the maximum loss-free dormancy period of a hitherto optimal cryo tank at operating pressure is in the range of approximately 3 days. That is, after this period of time, boil-off of a small subquantity of stored hydrogen is unavoidable, a feature that is not satisfactory in the day-to-day practice.

So-called cryo-compressed storage represents an additional known prior art, for which reason reference is made to the aforementioned U.S. Pat. No. 6,708,502 B1, which describes different types of insulated pressure vessels for cryogenic storage mediums with inner and outer diffusion barriers, which envelop a Carbon-fiber overwrapped pressure vessel (COPV) as inner tank. According to this prior art, the described so-called cryo-compressed tank can be filled with warm pressurized gas at 350 bar and at low storage capacity or as an alternative with liquid hydrogen at low pressure of approximately 1 bar (absolute) at higher storage capacity. During filling of the tank with liquid hydrogen, this known cryogenic pressure vessel exhibits (according to the description) a working pressure range between 1 bar (absolute) and 350 bar (absolute). The achievable physical storage densities range up to 71.5 g/l—that is, when filled 100% at 1 bar absolute pressure. Systemic storage densities reach values of up to approximately 33 grams per liter of system volume and/or 1.1 kWh per liter of system volume at the current state of the art.

The heat absorption capacity of a cryo-compressed tanks, filled with liquid hydrogen at 1 bar (absolute) and exhibiting a potential pressure increase of up to approximately 350 bar, is advantageously approximately 7 days per watt of average thermal input, and per kg of stored hydrogen. With the system according to this prior art (with approximately 150 liters of hydrogen, which is equivalent to being filled with 10.7 kg at 1 bar, and 10 W of maximum thermal input), loss-free dormancy periods in the range of 5 to 10 days can be reached at a maximum tank filling (with 10 kg liquid hydrogen) and approximately 30 days at an average tank filling (with 5 kg of liquid hydrogen), a state that reflects a dramatic increase over the aforementioned prior art.

However, the drawback with this prior art is that when the tank is filled at 1 bar absolute at the highest physical storage density, immediately after filling the tank it is not possible to provide pressure for a unit (for example, a vehicle drive unit or a fuel cell which is to be supplied with hydrogen for combustion purposes from the cryo-compressed tank. The reason is that this unit (or this fuel cell) needs the hydrogen to be under a slightly higher pressure, which for today's aforementioned components is in the range of at least 4 bar absolute. Consequently a time and/or energy intensive subsequent increase in pressure in the vehicle would be necessary to operate the drive unit or a fuel cell immediately after the tank is filled. Since there is no possibility of increasing the tank pressure or generating pressure on the way to the drive unit (or in general a consumer, which can be, besides an internal combustion engine, also a fuel cell) in real time and in an energy efficient way, the prior art cryo-compressed tanks do not fulfill the automotive boundary conditions.

Furthermore. a cryo-compressed tank of this type necessitates a lengthy tank filling process that exhibits high quantities of return gas due to the ensuing evaporation (with a sudden change in density) of the liquid hydrogen upon contact with super heated tank walls. That is, it is necessary to cool the cryo-compressed tank thoroughly prior to the permanent accommodation of liquid hydrogen. Furthermore, it is possible to detect an accelerated increase in pressure in the cryo-compressed tank, due to an inclination towards thermal stratification. Finally both a cryo-compressed tank of this type and its ancillary systems, which are loaded with the storage medium taken from the cryo-compressed tank, must be designed for a two phase operation of the storage medium (that is, the cryogenic hydrogen). As a result, (more intensive) material fatigue, caused by the boiling operations of the storage medium, must be considered.

One object of the present invention is to provide an improved method for filling a cryo-compressed tank, which avoids at least the drawback of the prior art described in connection with U.S. Pat. No. 6,708,502 B1.

This and other objects and advantages are achieved by the method according to the invention, in which, following removal from the large supply vessel, the storage medium is compressed, and is then introduced at super critical pressure into the insulated pressure vessel (in particular, the cryo-compressed tank).

That is, the cryo-compressed tank is filled with a cryogenic storage medium at super critical pressure by compressing (essentially adiabatically) the cryogenic storage medium, which was removed essentially under ambient pressure from a so-called large supply vessel located (analogous to the past liquid hydrocarbon fuels, like gasoline or diesel) at a “tank station”. As a result, the cryogenic storage medium is liquid. If the storage medium is hydrogen, then it is preferably compressed to a super critical pressure in a magnitude of 13 bar or more. (The critical pressure for hydrogen is, as is well-known, 12.8 bar). Therefore, on termination of the filling process of the cryo-compressed tank, the pressure level in this cryo-compressed tank is at the level of the super critical pressure value, which is sufficiently high to be able to supply a consumer (for example, the aforementioned vehicle drive unit or a fuel cell) with the storage medium (or rather, hydrogen), easily and without problems. Moreover, in this way the other drawbacks, described above in connection with a cryo-compressed vessel as the prior art, can be avoided or at least minimized.

In an advantageous further embodiment of the invention, the storage medium, which is removed from the large supply vessel and compressed, preferably by means of a cryo pump, can be re-cooled prior to introduction into the pressure vessel/cryo-compressed tank, essentially isobarically (or as isobarically as possible). (That is, such cooling reverses at least in essence the increase in temperature that is associated with the previous compression). In the case of hydrogen as the storage medium there occurs at the same time preferably a re-cooling to a temperature in the range of 20 K. In this way the storage capacity of the cryo-compressed tank is noticeably increased in an advantageous manner by cooling the compressed hydrogen at super-critical pressure to the temperature level of the sub-critical liquid hydrogen (of 1 bar absolute and approximately 20 K).

Regardless of the respective storage medium, it is especially advantageous if the latter, which is removed from the large supply vessel and compressed to a super-critical pressure, is passed for re-cooling purposes through a heat exchanger, disposed in the storage medium, and stored in the large supply vessel. The large supply vessel has, on the one hand, an adequate cooling capacity, and, on the other hand, the amount of heat that is introduced by the heat exchanger is advantageous with respect to the compensation for the removed amount of cryogenic storage medium.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a pressure-density diagram for cryogenic hydrogen; and

FIG. 2 is a schematic diagram of apparatus for performing the method according to the invention.

### DETAILED DESCRIPTION OF THE DRAWINGS

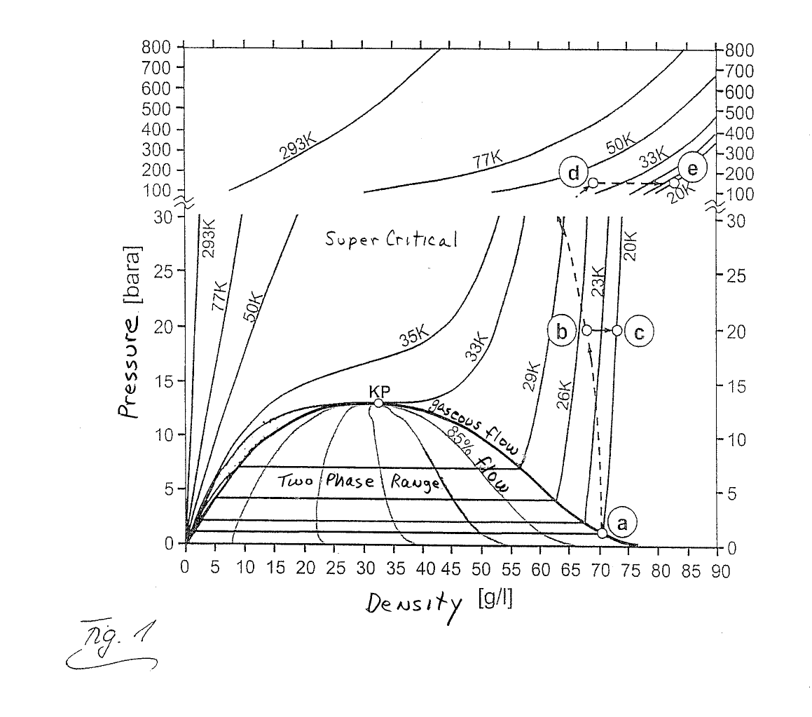

In the case of hydrogen as the cryogenic storage medium, the commensurate process steps are reproduced by way of one example in FIG. 1, which shows in essence a pressure-density flow chart. In this context plotted over the density in the unit “grams per liter (g/l)” is the associated absolute pressure in “bar” (=bara), where reference is made explicitly to the break in the ordinate. For this reason the respective isotherms (293 K, 77 K, 50 K . . . 23 K, 20 K) are also depicted with a break.

Hence, liquid cryogenic hydrogen is removed in a state according to point “a” (FIG. 1) from a large supply vessel (essentially under ambient pressure=1 bar as well as at a temperature of 20 Kelvin), and is then compressed as adiabatically as possible to a super critical fill pressure of 20 bara, so that point “b” is reached. Preferably thereupon the hydrogen is post-cooled or re-cooled as isobarically as possible essentially to the temperature of the liquid hydrogen, present in the large supply vessel (a magnitude of approximately 20 Kelvin), so that at this point only a state according to point “c” is reached. Then in this state the hydrogen (or rather in general the storage medium) passes in essence into the cryo-compressed tank that is to be filled. As an alternative, in order to achieve still higher densities, the hydrogen, removed from the large supply vessel, can be compressed, starting from point “a” to, for example, 150 bara (point “d”), and then can be re-cooled as isobarically as possible to approximately 20 K, as a result of which point “e” is reached.

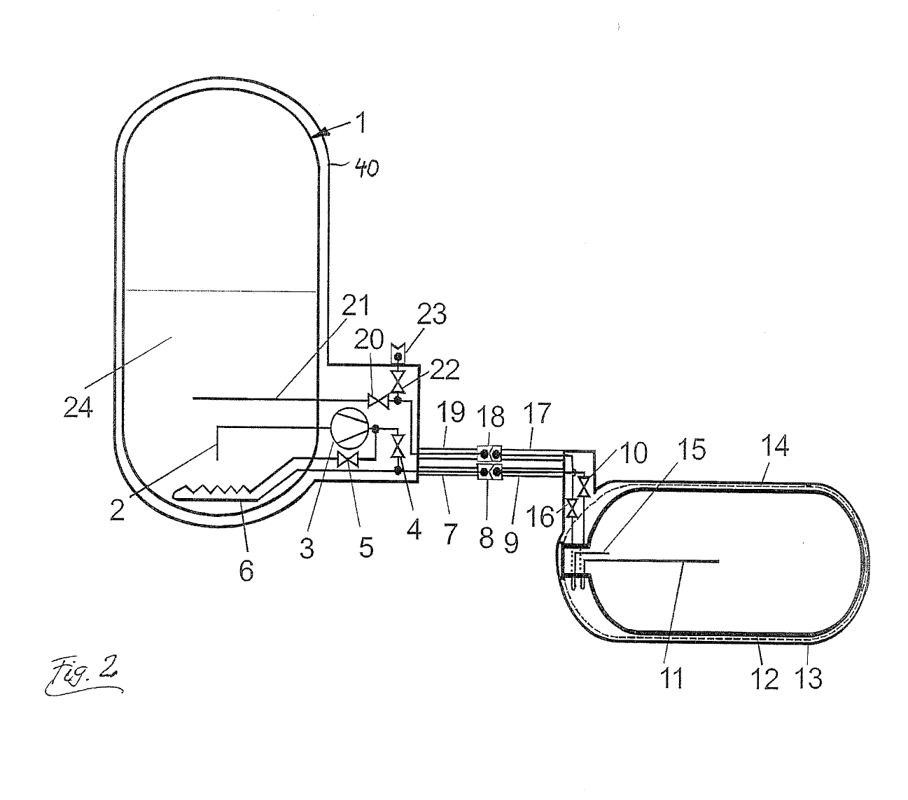

FIG. 2, discussed below, shows a device for carrying out the proposed method. For this reason, this method will be explained in detail once again below.

The reference numeral 1 denotes a large supply vessel, which is located, for example, at a tank station, and in which cryogenic liquid hydrogen 41 is usually stored at ambient pressure (=1 bara) and at a corresponding saturation temperature of 20.24 K. A cryo-compressed tank 12 located in a motor vehicle, is to be filled from this large supply vessel 1. That is, the pressure tank is to be filled with cryogenic liquid hydrogen from the large supply vessel 1. To this end, a feed line 9, which is assigned to the cryo-compressed tank 12 and connected by a cold valve 10 to a fill line 11 which empties inside the cryo-compressed tank 12, is connected to a supply line 7 of the large supply vessel 1 by means of a cryo-compressed tank coupling 8.

However, the supply line 7, by which the cryogenic hydrogen is ultimately delivered from the large supply vessel 1, does not empty directly into the cryogenic liquid hydrogen 24, stored in the large supply vessel 1. Rather the hydrogen 24, stored in the large supply vessel 1, is removed from the large supply vessel 1 by means of a liquid extraction line 2 and thereupon compressed to a super critical pressure level (that is, above the pressure value 12.8 bara) in a cryo pump 3 that is as adiabatic as possible. Then the liquid so-called cryo-compressed hydrogen, which is slightly heated due to this compression, is initially passed either by way of valve 4 directly or by way of a valve 5 through a heat exchanger 6 and then subsequently to the aforementioned supply line 7. In the heat exchanger 6, which is located inside the large supply vessel 1 in the cryogenic liquid hydrogen 24, which is stored in said large supply vessel, the so-called cryo-compressed hydrogen, which is passed through the heat exchanger 6, is re-cooled essentially to the temperature level of the stored cryogenic liquid hydrogen—that is, to approximately the aforementioned saturation temperature of 20.24 K.

Of course, the respective components, to the extent they are necessary, are adequately insulated. Thus, the large supply vessel 1 with the cryo pump 3 and the said valves 4, 5 is enveloped by an insulation 40. It is also apparent that the supply line 7, the coupling 8 and the feed line 9 are adequately insulated. Even the cryo-compressed tank 12 is provided in the conventional manner with a vacuum super insulation 14, which envelops the pressure tank 12, which receives the cryogenic hydrogen. This vacuum super insulation in turn is held in a vacuum tight outer tank 13, which envelops the pressure tank 12 so as to be at a suitable distance from the same.

If at the beginning of a desired tank filling process of the cryo-compressed tank 12, this cryo-compressed tank has a residual quantity of stored hydrogen, which has not adequately expanded yet, and if in order to increase the tank filling final mass, when the cryo-compressed tank 12 has a warm gas content, prior to filling the tank again, the pressure in the pressure tank can be decreased (that is, a depressurization can be carried out) by removing at least a fraction of the said residual quantity—that is, generally the residual storage medium, which is usually present in the gaseous state—from the cryo-compressed tank 12. This procedure is accomplished by a return gas line 15, which runs over a return gas valve 16 to an insulated line 17, the end of which has a return gas coupling 18.

Attached to the return gas coupling 18 can be an insulated feed line 19, which conveys this residual gas over a so-called supply tank valve 20 back into the cryogenic liquid hydrogen 24 of the large supply vessel 1. The recirculation of this residual gas or a fraction thereof can be used to compensate at least partially for the pressure loss that was caused in the large supply vessel 1 through the removal of liquid hydrogen in order to fill the tank. Especially in the case that the desired pressure is exceeded in the large supply vessel 1, excess residual gas can be delivered over a valve 22 and a coupling 23 and also to an external consumer or utilizer, which may be, for example, a stationary fuel cell or an attached pressure tank storage system.

The above described tank filling process has the following advantages.

It is possible to achieve high storage densities—for example, according to point “c” in FIG. 1, a 3.3% higher density than during the tank filling process of a cryo-compressed tank with cryogenic liquid hydrogen at a pressure of 1 bar (absolute) and/or a 12.7% higher density than in the case of today's conventional tank filling process, according to the aforementioned prior art, at a maximum pressure of 4 bar (absolute) in a cryo tank that is not designed for high pressure values. When the method, according to point “e” in FIG. 1 is implemented, the result is a 16.8% higher density with the use of a cryo-compressed tank and/or a 31.6% higher density than in the case of a tank filling process of today's conventional cryo tank that is not designed for high pressure values.

Almost immediately following a tank filling process of the cryo-compressed tank there is, in particular, adequate pressure available for the use of the cryogenic hydrogen (or rather the storage medium) in a unit. For example, a fuel cell needs a pressure level ranging from 4 bar to 10 bar (absolute), whereas for a charged hydrogen internal combustion engine a pressure level ranging from 8 bar to 20 bar is required.

It is possible to quickly fill in an advantageous manner the cryo-compressed tank, because there is no evaporation with a sudden change in density and, hence, there is no resulting fast increase in pressure when a non-cold tank is filled. The result is a shorter tank filling time and smaller return gas quantities, which, moreover, have been regarded to date on the part of the tank station as a tank filling loss. As stated above, it is still possible to use in an advantageous manner a here so-called residual gas quantity, which is returned to the tank station or rather into the large supply vessel 1.

Finally the presence of a super critical pressure rules out the need to pay attention to phase transitions, and, as a result, there is less inclination towards thermal stratification. The result is both lower material stress on the cryo-compressed tank and its ancillary systems and also a delayed buildup of pressure in the cryo-compressed tank during dormancy, when the vehicle is parked for a prolonged period of time (and, hence, no hydrogen is removed).

In comparison to the prior art, which was cited first in the introduction above, and which provides a cryo tank that can only accommodate a slight overpressure—that is, which can store cryogenic hydrogen only up to a pressure level of approximately 4 bar—the cryo-compressed tank, which is filled according to the invention, has the further advantage of a high loss-free dormancy period (of more than 20 days on average), during which minimum quantities of hydrogen have to be dispensed in any event. The result is that this cryo-compressed tank can hold a cryogenic storage medium up to pressure values of 300 bar or more. However, a significant improvement over simple cryo tanks, which can accommodate only a slight overpressure, is already achieved with a cryo-compressed tank that can withstand absolute pressure values in a magnitude of 150 bar. That is, the storage medium, stored in the cryo-compressed tank, can accept pressure values up to 150 bar, before venting must be initiated in order to decrease the excessive pressure values. When a cryo-compressed tank is used, instead of a simple cryo tank that is virtually unstable to overpressure, an adequate quantity of hydrogen always remains, as a function of the vent pressure, in the tank even after a long dormancy period subject to losses. Therefore, a vehicle that is equipped with such a cryo-compressed tank, can always be moved sufficiently. In order to guarantee maximum storage density and adequate pressure availability for the stored cryogenic hydrogen (or rather, in general, for the cryogenic storage medium), the invention utilizes, therefore, a quasi loss-free cryo-compressed tank with an adequately long loss-free dormancy period during removal mode, which is simultaneously without a boiling process, dormancy mode, and, in particular, tank filling mode, which is made possible by filling a cryo-compressed tank with a low temperature storage medium at super critical pressure.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for filling a motor vehicle pressure vessel for a cryogenic storage medium, in which pressure vessel the cryogenic storage medium can be stored under absolute pressure values on the order of at least 150 bar; said method comprising:
removing said cryogenic storage medium from a large supply vessel, in a liquid state at a saturation temperature under substantially ambient pressure;
following removal from the large supply vessel, comprising the cryogenic storage medium; and
introducing the cryogenic storage medium into the insulated pressure vessel at super critical pressure.

2. The method according to claim 1, wherein the cryogenic storage medium comprises cryogenic hydrogen.

3. The method according to claim 1, wherein the compressed storage medium is re-cooled prior to introduction into the insulated pressure vessel.

4. The method according to claim 3, wherein the storage medium is passed for re-cooling purposes through a heat exchanger, disposed in the storage medium, stored in the large supply vessel.

5. The method according to claim 1, wherein the storage medium is compressed using a cryo pump.

6. The method according to claim 2, wherein said hydrogen is compressed to a super critical pressure in a magnitude of at least 13 bar.

7. The method according to claim 2, wherein said hydrogen is re-cooled to a temperature in a magnitude of 20 K.

8. The method according to claim 1, wherein prior to a tank filling process with new storage medium, residual storage medium, contained in the insulated pressure vessel/cryo-compressed tank, is removed from the insulated pressure vessel.

9. The method according to claim 9, wherein the removed residual storage medium is returned into the large supply vessel.

10. The method according to claim 9, wherein the removed residual storage medium is returned to a consumer or a pressure tank storage system.
